(19) United States
(12) Patent Application Publication
(10) Pub. No.: US 2002/0184308 A1
(43) Pub. Date: Dec. 5, 2002

(54) Globalization and normalization features for processing business objects

(76) Inventors: Martin J. Levy, Campbell, CA (US); Maki Sakata, Kita-Ku (JP); Rajiv Vij, San Jose, CA (US)

Correspondence Address: McAndrews, Held & Malloy, Ltd., 34th Floor, 500 W. Madison St.,, Chicago, IL, 60661, US

(21) Appl. No.: 10/027,570

(22) Filed: Oct. 25, 2001

Related U.S. Application Data
(60) Provisional application No. 60/164,021, filed on Aug. 23, 1999.

(51) Int. Cl. G06F 17/00; G06F 9/00; G06F 15/16

(52) U.S. Cl. 709/203; 707/102; 709/103

(57) ABSTRACT

A globalization system for processing data in a multiple-locale or multilingual environment. A range of functionality is provided through various classes and interfaces that can be associated with subsystems running in the environment. These interfaces and classes provide for the development of subsystems (i.e., applications, servers, adapters, and so forth) that are independent of knowledge of languages and data formats of a particular locale. A locale associated with various data can be used to dynamically configure information. A normalization capability is also provided for standardizing the representation of data coming into a processing domain from various locales.

### RELATED APPLICATIONS

This application is related to the following—U.S. Provisional patent application having Serial No. 60/164,021, entitled “Method and Apparatus to Provide Custom Configurable Business Applications from a Standardized Set of Components,” filed Aug. 23, 1999; Utility patent application having Ser. No. 09/440,326, entitled “Method for Providing Custom Configurable Business Applications from a Standardized Set of Components,” filed Nov. 15, 1999; Utility patent application having Ser. No. 09/439,764, entitled “Apparatus to Provide Custom Configurable Business Applications from a Standardized Set of Components,” filed Nov. 15, 1999; Utility patent application having Ser. No. 09/658,415, entitled “Method for Developing Custom Configurable Business Applications,” filed Sept. 8, 2000; Utility patent application having Ser. No. 09/658,416, entitled “Integrated Design Environment for a Commerce Server System,” filed Sep. 8, 2000; Utility patent application having Ser. No. 09/684,491, entitled “Adapter and Connector Framework for Commerce Server System,” filed Oct. 4, 2000; Utility patent application having Ser. No. 09/691,461, entitled “Method and Apparatus for Providing News Client and Server Architecture and Protocols,” filed Oct. 17, 2000; Utility patent application having Ser. No. 09/697,271, entitled “Method for Providing Template Applications for Use by a Plurality of Modules,” filed Oct. 25, 2000; Provisional patent application having Serial No. 60/243,580, entitled “Globalization Services for Business Commerce Server,” filed Oct. 25, 2000; Utility patent application having Ser. No. 09/702,148, entitled “E-Commerce Application Built Using Workflows on a Workflow Engine and Methods Thereof,” filed Oct. 30, 2000; Utility patent application having Ser. No. 09/702,290, entitled “Presentation Layer for Business Application Development and Methods Thereof,” filed Oct. 30, 2000; Utility patent application having Ser. No. 09/702,291, entitled “Scalability, Availability, and Management Features for Business Commerce Server,” filed Oct. 30, 2000; Utility patent application having Ser. No. 09/706,304, entitled “Content Management Framework for Business Commerce Server,” filed Nov. 3, 2000; Utility patent application having Ser. No. 09/727,912, entitled “Workflow Driven Rules-Based Generation of Personalizable Web Pages,” filed Nov. 28, 2000; Provisional patent application having Serial No. 60/280,240, entitled “Data Driven Entitlement,” filed Mar. 30, 2001; Utility patent application having Ser. No. 09/837,070, entitled “Data Driven Entitlement,” filed Apr. 18, 2001; Utility patent application having Ser. No. 09/893,134, entitled “Menu Infrastructure Apparatus and Method,” filed Jun. 27, 2001; Utility patent application having Ser. No. 09/925,241, entitled “Rule Based Personalization Framework,” filed Aug. 8, 2001—each of which are hereby incorporated by reference in their entirety.

### FIELD OF THE INVENTION

The present invention relates to an apparatus and method for providing globalization service for processing a business object. In particular, normalization (and denormalization) of business data is performed which is abstracted as a business object, and passed between devices such as data sources, processing servers, applications, and users. The present invention provides a configurable, multi-locale software service for working with data objects in a multilingual software environment and for interfacing with different multi-locale data sources.

### BACKGROUND OF THE INVENTION

Asera system. The prior referenced applications provide for methods and apparatuses for creating custom configurable business or channel applications from a standardized set of components. More specifically, the referenced invention(s) allow(s)each business to select from a set of applications, customize that set of applications, and/or develop new customized applications from a set of development components. The prior applications provide for a server-based method wherein best-of-breed services and/or applications are integrated in a seamless fashion and offered to enterprise businesses which develop customized business service applications through using the system. The server device is previously (and hereafter) referred to as the Asera Commerce Server (ACS).

The ACS includes a Commerce Server that provides a core set of technology (or application) services. A unique architecture and framework are provided by the Commerce Server which facilitates development and use of customized applications. Most interactions with external systems or Users are managed as Business Objects. The service application code is maintained separate from the data. This enables the system to quickly include (and/or change) new business processes or technology components without having to write substantial amounts of new code. The business result is more rapid customer deployments and/or modifications that are customized to include (if desired) the proprietary or competitive business practices of a contracting company.

The ACS can be viewed as an eBusiness Operating System and provides an open and extendable architecture that allows a system to implement a customer specific business solutions in a short period of time. The ACS takes best-of-breed applications and incorporates them into one integrated solution. The architecture is scalable and extensible. A customized business (or channel) application solution is built for each enterprise company. The solution uses a “modular” or step-wise or “plug and play” approach towards building new applications. An enterprise company can then quickly acquire a turn-key e-commerce solution to automate their channel relationships. The system presents little (or no) risk for the enterprise company because a solution is built by the present system. The costs of undertaking such a development exist as a fixed development cost of the system. Any resulting customized solutions are implemented in considerably less time than previous systems. The enterprise company might pay for the application services on a cost per transaction, or a fixed fee basis.

The ACS is used to capture the particularized (or specific) business processes for a given customer, and these business processes are converted into a set of customized applications. The ACS uses business steps and rules to construct the application. The objects are data representations. The steps are business operations with a defined set of input and output ports, with each port also having a defined set of parameters. The business rules are used to capture customer specific business practices. A unique tool that employs a Graphical User Interface (GUI) allows a developer to arrange various steps (or composite steps) into business processes or workflows. The tool provides library catalogs of steps to be applied to the various objects. The connections between steps are also verified as correct. A graphical display of the business process is shown, and rules can thereafter be applied to provide further customization by conditionally tagging certain points. Hence, to create a business process (or application) for any given business, tools are provided which allow modules (or steps) to be plugged or dropped into the potential process. The steps can be moved or the connections modified. An initial person-to-person (or other type of) interview with the business (or customer) can be used to produce the framework for arranging the steps according to the needs of that particular business (i.e., customized routines). The modular aspect of the present system allows this to be done—and modifications made—in a relatively quick fashion. For instance, if a process has been created, but the customer wants it to behave in two different manners, then certain rules can be applied to provide the desired results, depending on conditional triggers that can be associated with the underlying Business Objects.

Prior Globalization Services. Globalization services are needed for the processing of data in a variety of languages and/or locations. Prior systems handle different forms of data by converting from one display format to another. The data might be in many different forms (or formats), and the various devices associated with the system must be able to compensate (or convert) the data in order to utilize the information. Without proper compensation (or conversion) of the data, incompatibilities between devices can arise, and overall system performance can be degraded.

In prior devices, this conversion might take place on an ad-hoc or device-by-device basis. Accordingly, FIG. 1 shows a representative block diagram of a prior art processing system 100, wherein “raw” data is retrieved from a database 102. A first device or application (Device1 or Application1) 104 is shown employing a conversion routine 106 (or other functional equivalent) to convert the incoming raw data 103 into a first data format (Data Format1) 108. This internalized data format would be used within Device1 (or Application1) for convenient exchange of information. A second device or application (Device2 or Application 2) 120, however, is shown requesting data from Device1. This data will be in Data Format1 108 and generally unusable by Device2 (or Application2). Device2 (or Application2) will therefore include a conversion routine (or the like) 124 to convert incoming data into a second data format (Data Format2) 126. A third device or application (Device3 or Application 3) 130 is shown receiving data from Device2 (or Application2) in Data Format2 126. Device3 (or Application 3) will similarly include a conversion routine (or the like) 132 to convert any incoming data into third data format (Data Format3) 134. The cycle of the data flow is completed (in this example) by certain data being stored back onto the database 102, which needs the data in a raw (i.e., unformatted) state. In order to prevent incompatibilities, a conversion routine (or the like) 140 is shown external to the database 102. This routine might be used to convert the data from the incoming format (i.e., Data Format3) back to raw data for storage on the database.

This example prior art system is problematic in that each Device or Application requires a separate conversion routine. The data is inefficiently converted with each new step into a plurality of different formats in order to be transported between the Devices and/or Applications. The conversion routines (hardware, software, firmware, or the like) might be included with the Device or Application. Alternatively, external routines might be included at any point along the data transport path.

Instead, what is needed in the field is an apparatus or method that provides for globalization services based upon the locale of the individual needing the data. Accordingly, normalization and denormalization is performed on finite pieces of data that can be transported within a system or between elements comprising a system. This approach could be used to standardize the globalization and/or normalization process for data.

The GS also serves to govern how locale-sensitive data is interpreted and formatted across any locale in a multilingual environment. The GS provides support for all date and time-related data (i.e., date, time, time zone, etc.), currency data (local and international formats), and numeric data (integers, floating point, and percentages). In addition to this, the GS provides a mechanism that is dynamically sensitive to the locale and which accesses locale-specific information. This information can include translated text and images that reside in externalized resource files specifically designed and structured for the requirements of localization.

One important aspect of globalization provides for the normalization and denormalization of object data (i.e., business object data), which is an abstraction of certain associated data. Data coming from a data source will have a conversion routine applied to its particular character set. The data might then be represented as a native business object in a particular format required by an interfacing device (or routine) that will use the native business object. Normalization will be performed on a native business object by a routine that utilizes mapping information from a configuration instance (or file). A flag within the business object will be set to indicate that the object has been normalized, otherwise the flag within the native business object will not be set.

The schema of the business object can be structured in a hierarchical manner, and an access mechanism can be applied for dynamically retrieving locale-specific text and image message resource elements. Thereafter, the processing system utilizes the normalized business object with the data in a standardized format, such as Universal System Format (USF), or the like.

When the data needs to be passed to another external or interfacing device (or routine), a denormalization routine is applied which uses, among other things, a user identifier to retrieve information particular to that user. This information might again be stored and retrieved from the global configuration instance (or file). The user identifier might be based upon the user locale or other such information. The denormalization results in a native business object to be used by the device (or routine) that was requesting the data. Yet another character-set conversion might be applied thereafter in order to provide the data in a form required by an end user, accessing the data via a browser or the like.

Accordingly, one aspect of the present invention provides for a globalization system for processing multi-locale information being sent to and received from a variety of external sources, the globalization system comprising: a server domain having information objects to be processed and displayed; at least one locale indicator associated with each information object; and a locale-sensitive mechanism associated with processing the information objects for accessing certain locale specific information, whereby the locale-specific information is used to uniformly process the information object according to certain requirements of the locale.

Another aspect of the present invention provides for a multi-locale processing configuration for uniformly processing multilingual information being sent to and received from a variety of external sources, the processing configuration comprising: a processing domain for containing information objects to be processed; at least one locale indicator associated with each information object; and a mechanism for accessing certain locale-specific information, whereby the locale-specific information is used for the parsing, formatting, and transformation of multilingual data in a multilingual software environment.

Another aspect of the present invention provides for A multi-locale processing configuration for uniformly processing multi-locale information being sent to and received from a variety of subsystems, the processing configuration comprising: a processing domain for running the variety of subsystems having a locale indicator; at least one interface associated with each different subsystem, the interface being used to facilitate the handling of different formatting and data conventions between subsystems; a mechanism for accessing locale-specific information based upon the locale indicator for each subsystem; whereby the subsystems interact with each other based upon the locale-specific information, and whereby the code within the interface frees developers from needing certain detailed knowledge about any particular language.

Another aspect of the present invention provides for a multi-locale processing configuration for performing normalization and de-normalization of data objects being used within a processing system, the configuration comprising: a processing domain having a variety of information objects; at least one integration interface for sending and receiving outgoing and incoming un-normalized information objects from an external system; a normalization routine to normalize the incoming information objects to a normalized representation; and a de-normalization routine for un-normalizing outgoing information objects from the normalized representation.

The above and other features, aspects and advantages of the present invention will become apparent from the following descriptions and attached drawings.

### BRIEF DESCRIPTION OF THE DRAWINGS

Certain aspects and advantages of the present invention will be apparent upon reference to the accompanying description when taken in conjunction with the following drawings, which are exemplary, wherein:

FIG. 1 is a representative block diagram, according to one aspect of the present invention, showing a prior art exchange of converted data between devices within a processing system.

FIG. 2A is a representative block diagram, according to one aspect of the present invention, showing an overall structure with elements pertaining to globalization and normalization.

FIG. 2B is a representative block diagram, according to one aspect of the present invention, showing components and use of a globalization service object.

FIG. 2C is a representative block diagram, according to one aspect of the present invention, showing un-normalized and normalized objects passing between a domain server and external systems.

FIG. 2D is a representative block diagram, according to one aspect of the present invention, showing a user interface.

FIG. 3 is a representative block diagram, according to one aspect of the present invention, showing conversion and passing of data from a data source, through a processing system, and back out to a browser.

FIG. 4 is a representative block diagram, according to one aspect of the present invention, showing different aspects of normalization and denormalization.

FIG. 5 is a representative block diagram, according to one aspect of the present invention, showing example data as converted between the different types of objects as they are positioned through the system.

FIG. 6 is a representative block diagram, according to one aspect of the present invention, showing representative parts of the global configuration instance (or file).

FIG. 7 is a representative block diagram, according to one aspect of the present invention, showing the process for converting the various attributes in the normalization of a business object.

FIGS. 7A, 7B, and 7C are representative structures of the Base Business Object, the Business Object Definition, and the Global System Configuration, as associated with the examples in FIG. 7.

FIGS. 8A-8K show representative coding samples and tables, according to one aspect of the present invention, that might be used for an example implementation of the normalization and denormalization process.

FIG. 9A shows a representative coding sample of mapping using a Locale Map definition.

FIG. 9B shows a representative coding sample of mapping using a Normalization Class Map definition.

FIG. 10A shows representative code for a customized Date Normalization routine.

FIG. 10B shows representative code for use with the class shown in FIG. 10A for date type attribute normalization

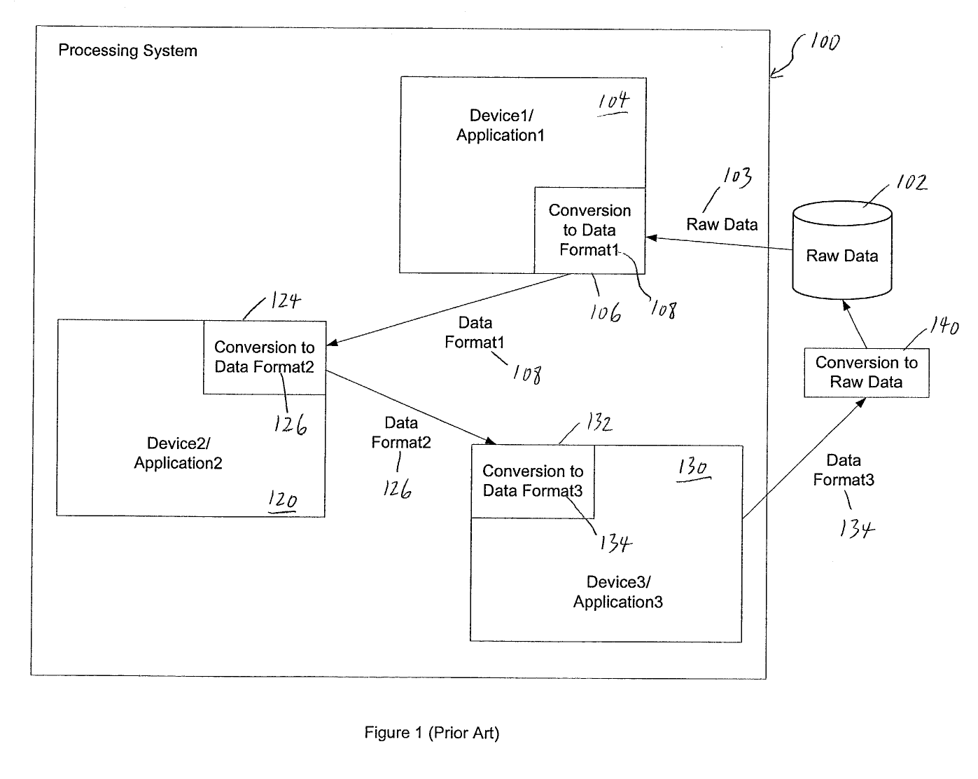

### DESCRIPTION OF THE PREFERRED EMBODIMENTS

Certain aspects of business object normalization will now be described in relation to the Asera Commerce System (ACS). The inventive principles associated with normalization (and de-normalization) are fully meant to be applied to other systems, but are described in relation to ACS for example purposes only. The Globalization Services (GS) described herein might also be referred to in terms of the Asera system, and hence be referred to AGS (Asera Globalization Services), despite being wholly applicable to other systems. Normalization (and de-normalization) are further described in relation to multilingual data objects in a multilingual software environment that interfaces with multiple, multi-locale data sources.

Moreover, data is generally passed around a system in the form of some discemable unit, but in order to be properly interpreted by each receiving part of the system, the data should be in some standardized form. The present invention is described in terms of a business object being an abstraction of the associated business data. In more generalized terms, a data object is an abstraction of the associated data, and the present invention in not intended to be limited to the described business object examples.

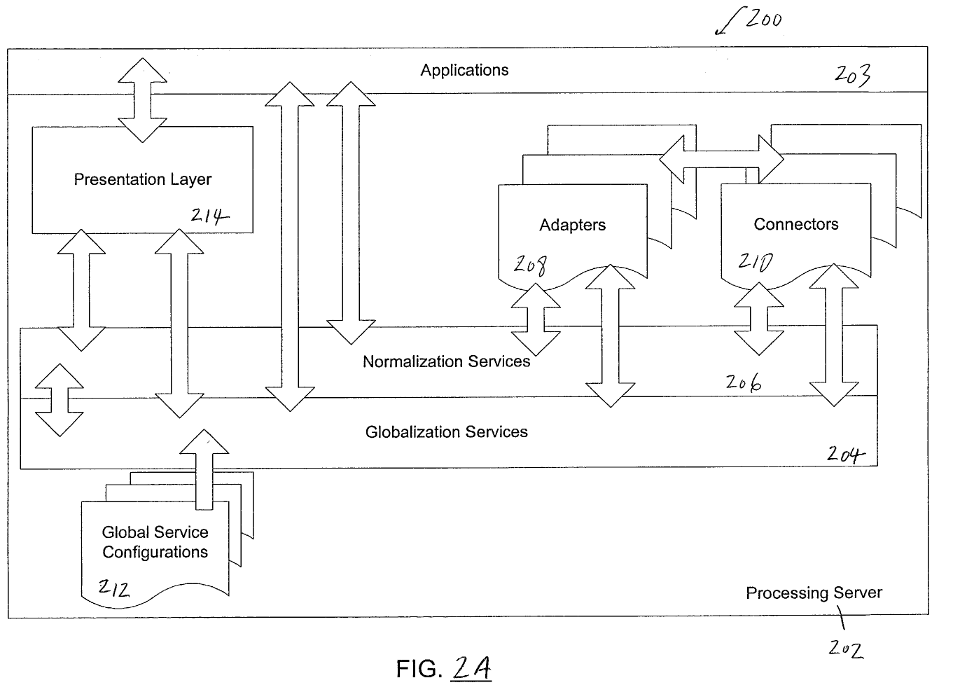

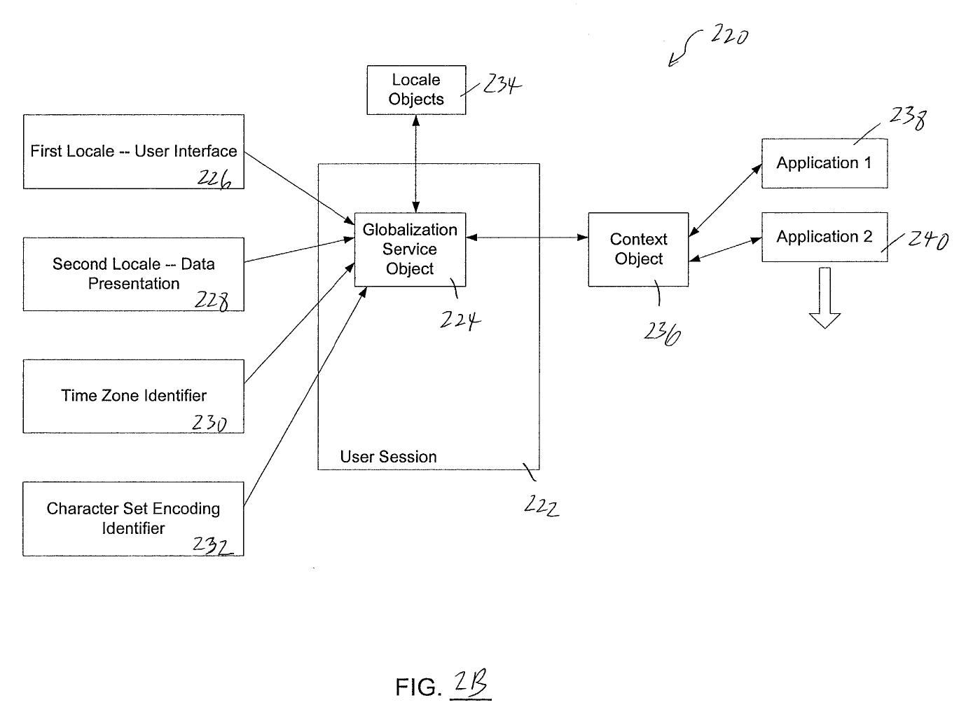

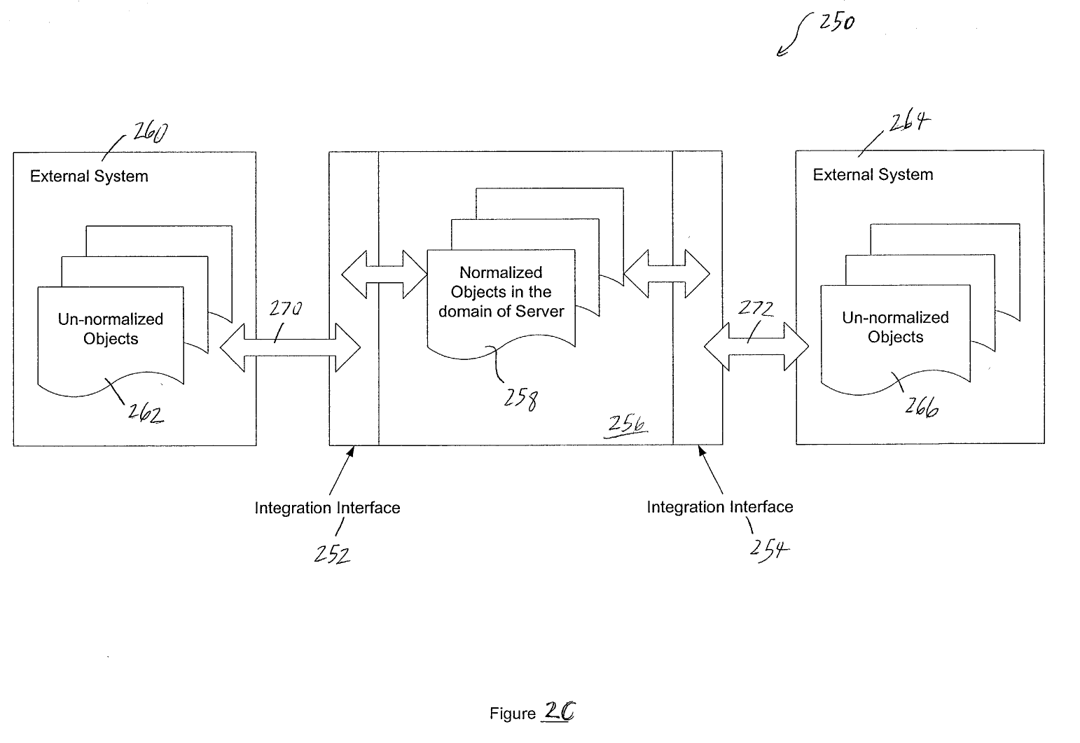

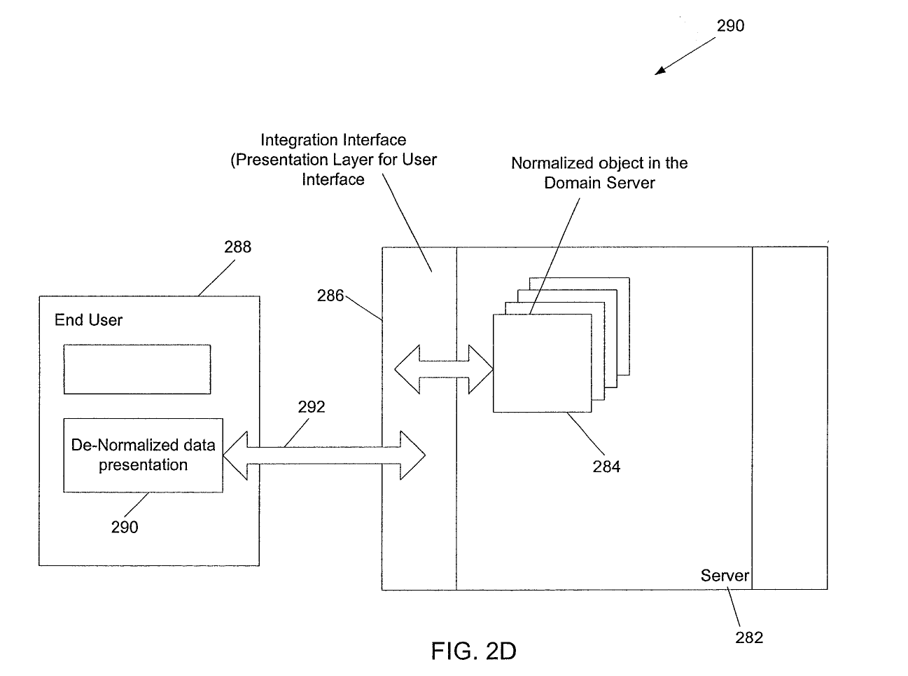

Overview. In general, the AGS is a tightly integrated collection of globalization services that enable systems to support globalization requirements in various system interfaces and subsystems. FIG. 2A shows a representative block diagram of the overall system 200 as it integrates various aspects of the present invention. The main part encompassing these various services is the processing server 202. This processing server, among other things, provides for the running of various applications 203. Included within the processing server 202 are certain layers and configurations shown to demonstrate aspects of the present invention. The various arrows between the elements connote the interaction of the elements and/or the communication of data therebetween. A layer of globalization services 204 is shown, along with a layer of normalization services 206. A series of adapters 208, and a series of associated connectors 210 are shown in communication with each other and interacting with the layers 204 and 206. Certain global service configurations 212 are shown interacting with the global services layer 204. The applications are shown having direct interactive access to the globalization services 204 and the normalization services 206.

A presentation layer 214 can also be used to render various aspects to the user (via an application). The presentation layer provides the logic for the interface between the platform (i.e., Asera platform or the like) and the user. The user interface becomes an important part of localization. Display filters provide dynamic multilingual functionality according to the Locale context. Messages and images are referred to by resource identifiers and are resolved at runtime. Data formatting is performed dynamically at runtime according to the user Data Locale. Similarly, user input values are dynamically interpreted at runtime according to the user Data Locale. The presentation layer also provides a mechanism for custom formatting capabilities when exceptions to the default Locale formats are required. Unlimited custom resource files can be created and used by each application. Additionally, page presentation may be customized and localized for each Locale.

The globalization system is based upon a multi-Locale model. All of the objects in the system are associated with a Locale identifier. A Locale represents language in a country or territory (i.e., English in the U.S., English in the U.K., German in Germany, Japanese in Japan, and so forth). One related benefit to this approach is that more than 90% of all application code is then reusable across all Locales.

FIG. 2B shows a set of representative blocks 220, which serve to demonstrate certain aspects. A user (or user session) 222 is shown. Each user 222 has two Locales. The first Locale 226 governs the User Interface, and the second Locale 228 governs the Data Presentation. Each user has a specific Time Zone identifier 230 which is used to influence all date-time related operations. In addition, each user has a Character Set Encoding identifier 232 which is applied to all HTML pages that are generated.

The combination of these four elements together constitutes (for this particular example) the globalization service object 224. Each user session is given its own GS object which allows each user to have specific personal language preferences. A GS object is instantiated for each user session by providing the Locale name in the application entry point query string. The GS Object 224 is thereafter made accessible to applications, i.e. Application 1 (238), Application 2 (240), and so forth, via the Context Object 236. The Locales in the GS object might be represented via “ALocale” objects, which can provide numerous Locale based services.

The presentation layer uses the GS object in order to support Locale-sensitive operations. Other system components might need to utilize the GS object for normalization and de-normalization. Multiple GS environments can exist in a platform-server environment. Hence, different system components can have GS environments that are specifically configured for their specific requirements. Moreover, GS objects from multiple environments can co-exist with different Locale configurations.

Each GS environment can be configured through a specific configuration file. This configuration file can be specified using separate entries in the “SERVER.XML” file. Each GS configuration file can be configured to support multiple Locales, and each Locale can be individually configured to support different default Locale behavior. In addition, certain GS mapping tables can be defined in the GS configuration files, either as embedded mapping or as separate mapping XML files. Languages can be incrementally added to any GS deployment through the localization process. Locale-specific elements will generally reside in specific Locale-named directories (i.e., Filters, Resources, CSS, etc.). GS Resources are then stored in XML documents in one of two possible schemas (i.e., a message schema or an image schema).

Referring now to FIG. 2C, a representative block diagram 250 is shown of the GS normalization services. Normalization services will allow integration interfaces 252 and 254 to be enabled in order to integrate (i.e., transmit and receive) multilingual data (or the like) from various systems concurrently. Integration interfaces might include adapters, connectors, or the like, as described below and in the documentation incorporated by reference above. The AGS normalization services rely on AGS foundation classes and interfaces to provide the specific parsing and formatting services in a dynamic and multi-locale manner.

The AGS works on the basis of normalization and de-normalization. The server can be thought of as a domain with distinct borders (i.e., interfaces, or points of integration) where data is represented inside objects in a uniform manner within the domain. The details pertaining to a data representation are referred to as the Universal System Format (USF). This format (or another standardized format like it) are important components in providing consistent processing in a multilingual environment. A server domain 256 is shown with a set of normalized objects in the domain of the server 258.

Outside of the server domain 256, the data representation is considered to be un-normalized. The integration interfaces 252, 254 then take on the responsibility to use the appropriate AGS normalization services. The AGS normalization services work on objects and individual data elements/attributes. Every integration interface can be configured through an external configuration file. There are many data elements that can require normalization and de-normalization when transmitting and receiving data through a particular integration interface. A first external system 260 is shown having a set of un-normalized objects 262, and a second external system 264 is shown having a set of un-normalized objects 266. In the normalization model, incoming data 270, 272 enters through the integration interface 252, 254 and is transformed from an un-normalized state into a normalized state (i.e., USF). Similarly, outgoing data transmitted through the integration interfaces is de-normalized to the representation required by the external (or “native”) system 260, 264.

Normalized objects are therefore free to pass in and out of any integration interface. Objects normalized into the server from one integration interface can be transmitted out from the server to any other integration interface, as required or needed.

A business object is an abstraction of the business data, and the continued examples below will refer to business objects in describing the present invention. The business data is passed around the system in the form of the business objects. Inside of the ACS system, all the business data in the business object should be normalized into a single system format, including time zone and encoding, which is in USF. All of the date, time, currency, and number data should be in a single format no matter where the data originated or from where it was transferred. When the business object comes to the point where it interacts with the outside world, the data needs to be transformed to the format that is required by the corresponding data source or destination.

Character set encoding normalization. Before any incoming data can be fully processed, the data stream must be converted from the external systems character set encoding scheme to the normalized encoding scheme (defined for example purposes herein as USF). This can be configured in the interface-specific configuration file, or it can be determined dynamically via programmatic methods. The normalization services 206 provide configurable mapping interfaces that allow normalization between technology/vendor-specific naming conventions (i.e., character set encoding names, time zone identifiers, locale identifiers, currency identifiers, etc.). Once the normalized character set encoding name is known, the normalization services 206 can be used to provide character set encoding conversions to and from the USF encoding (i.e., UTF-8). For instance, Shift-JIS to USF, ISO 8859-2 to USF, IBM EBCDIC to USF, etc.

Technology/vendor identifier normalization. After character set encoding normalization, technology/vendor-specific naming conventions must be normalized. Time zone identifiers, locale identifiers, currency identifiers, etc., must be normalized to the USF format. These are defined externally in mapping files and are utilized through the normalization services. For instance, MIME to USF, ISO4217 to USF, Oracle Language/Territory to USF, Microsoft LCID to USF, etc.

Data Normalization. There are various data elements/attributes that require normalization. For instance, incoming date/time string-related data must be transformed from an external specific representation to the normalized representation (USF). It is possible that each incoming data element has a different un-normalized representation depending on the locale of the object being processed. Also, in the case of date/time data, each element could be represented relative to a specific time zone. Un-normalized data (or time data) must be normalized with respect to the particular data format (or time zone). Moreover, currency data elements may require the normalization of currency unit identifiers to the USF format. This can happen at the data element or object level or at the interface level.

User Interface. Although the rendering of a user interface requires many technologies (see incorporated references above), it is still considered to be an interface or point of integration and therefore requires normalization and de-normalization. Normalized data objects are required to be presented to the user in a locale-sensitive manner. Each user has specific cultural requirements and preferences and therefore requires that the server/presentation layer interface will de-normalize the outgoing data to the user according to the configured AGS and normalization rules dynamically.

FIG. 2D shows certain representative blocks 280 that serve to demonstrate these aspects. A server 282 is shown with normalized objects 284 within the domain of the server. An integration interface 286 (or Presentation Layer) is shown interacting with the normalized objects. The end user 288 then views de-normalized data as presented from the integration interface 286.

The presentation layer 286 can be considered a special case of a system interface, and in a multilingual environment, it requires two individual locales, i.e., one for each user. One locale is required to govern the generation of the main form/page/screen. Another locale is required in order to govern the manner in which the data elements are formatted and/or presented to the user.

Data flowing in the opposite direction faces similar conversion requirements. For instance, when a user types data into the user interface, the data 292 sent to the server is considered un-normalized, and it requires normalization before it can be processed within the server 282.

A class of “helper functions,” or the like, can be provided. While these functions might be labeled or named according to the particular system, the present example refers to them as “BusObjNormalization.” These helper functions serve to normalize and denormalize business objects when they get transferred to/from outside of the ACS or other such systems.

Referring now to FIG. 3, a block diagram 300 is shown with representative elements that further illustrate the normalization process in terms of globalization aspects. A processing system 302 is shown, which generally operates on a normalized business object 304. A data source 306 is shown providing information to a representative integration interface which, in this instance, is shown as a Connector 308. The data coming from the data source 306 is first put through a character set conversion 320. The information will exist in the connector (or other such device) as a native business object 322. The business object thereafter goes through normalization, as representatively shown by the arrow 330, before entering the processing system 302. The normalization routine 330 will utilize a global configuration file, which in the present example is shown to include mapping of elements associated with each native business object.

When an object exits the processing system, to be used by another device or apparatus (or the like), it is denormalized by a routine or device which is representatively shown by the arrow 340. The object can be denormalized according to the needs of different users, shown as User 1 (342), User 2 (344), and so forth, through User N (346). The global configuration file 332 (or a separate file serving the same purpose) can be used for retrieving formatting information pertaining to each particular user. The denormalization routine 340 will use this formatting information to produce a native business object 324 which is used by a receiving device or routine. In the present example, a Filter 350 is shown receiving (and using) the native business object 324.

Thereafter, a browser 360 might be used to receive and display the information in the native business object 324. A character set conversion 370 is applied to the native business object in order to provide text and/or numbering that is readable by the particular user of the browser 360.

Note also, that each of the business objects includes a common flag which is used to keep the state of the business object, for instance, if the object has been normalized or not. This flag is shown as 310 in association with the normalized business object 304 and the native business objects 322 and 324.

As shown in the block diagram in FIG. 4, normalization and denormalization 402 might include the following aspects in the normalization helper class: character set conversion 404; data normalization 406; data formatting 408; custom normalization 410.

For character set conversion 404, the universal character set for the internal business object representation is “Unicode.” The native character sets for the corresponding outside components might include ASCII, Latin-1, or Shift-JIS. For example, and ERP system might pass its data to the processing system using Shift-JIS. Alternatively, the browser may want to receive HTML in Latin-1. The representative Filter 350 and connector 308 can call the appropriate method in the BusObjNormalization class to get the data in the correct, desired encoding format (i.e., native character set to Unicode and vice versa).

Data normalization 406 can be implemented using any of a variety of attribute types. Representative types might include: (1) Business object locale, which can serve to identify the locale of the data source or data, map a native locale name to the system locale name (if required), and/or set the locale in a base document object (i.e., the present embodiment using BaseDocObj). (2) Currency, wherein a currency locale needs to be normalized from the data source currency to the processing system currency mode. (3) Date/Time, wherein the date needs to be normalized to the system time zone configured in a partitioned configuration. The attribute types are not limited to these representative examples. If the Business Object Definition (BOD) contains attributes of the data types above, the adapter will need to perform appropriate mapping or conversion.

Locale Negotiation. The Locale referenced above can be selected via principles of negotiation. Locale negotiation can be used to provide the ability to intelligently select the most appropriate Locale or Locales for a given application context. For instance, given a list of a user's preferred operating currencies, the application logic should be able to determine the most appropriate currency-specific price list.

There are many possible scenarios where this type of logic is needed. Globalization services provides a “LocaleNegotiation” class to provide a means for this application requirement. The LocaleNegotiation class will keep a Vector of the possible locale names and the weights of the elements for comparison in each instance. To perform the negotiation, a LocaleNegotiation instance needs to be created, and a list of possible or available locales is passed to it. Each LocaleNegotiation class should have at least one possible locale. The locales can be passed in the constructor, the first one being the default locale (i.e., if there is no locale match with the requested locale in the list, the default locale should be chosen).

Thereafter the weight for each element might be set via the command: negotiation.setLocaleWeights (WEIGHT_MUST, WEIGHT_OPT, WEIGHT_ALT). For the purposes of this example, the first variable corresponds to the weight of the language, the second the weight of the country, and the third the weight of the variant. According to the example chart above, this means that the language has to match; the country is optional, but if it exists, it has to match. If the two possible locales match on language and country, then the one that matches on variant will be selected. If multiple locales are matched using the weight, the one that is higher in the list should be chosen. If none of the supported locales matches, then the default locale is used.

This class allows developers to ignore specific detailed user requirements and system locale availability. By using the appropriate class methods, the developer is able to get either an absolute Locale to use in a particular context or a list of appropriate Locales for the context.

Examples of Locale negotiation might include (but are not limited to): Allowing users to read Message Boards or News Feeds created in other languages; Allowing users to filter Auctions, RFQ and OTS preferred languages; Determining which currencies that a user prefer to use for buying and selling. In a multilingual system, Locale Negotiation should get the best match Locale according to the user's preferences from the list of locales supported by the system. Negotiation is usually performed between a fixed number of locales that the system supports and a requested locale or list of locales.

Locale negotiation facilitates (but is not strictly limited to) the following functionality: Provides the suitable locale or list of locales, given a list of available locales and a requested locale or list of locales; Provides the ability to set weighting on language/country/variant so that application can select the most appropriate locale according to certain criteria; Provides an extensible base class which implements basic locale comparison and negotiation.

Different representative scenarios might require locale negotiation. One common example of Locale Negotiation is for web-based applications. The HTTP protocol has the basic construct required. The HTTP Accept-Language request-header field restricts the set of natural languages that is preferred as a response to the HTTP request. Users usually set this up by configuring their browser preferences. The browser will automatically generate a request-header whenever it sends a request to the server.

Each user's preferred language can be given an associated quality value which represents the estimate of the user's preference for the languages specified. For example, the code: Accept-Language: da, en-gb; q=0.8, en:q=0.7, would mean this user prefers Danish but will accept British, English, and other types of English.

In order to take advantage of the HTTP Accept-Language header information, and to apply it to Locale Negotiation, the server platform is required to identify the language preferences. In this situation, the platform provides a list of locales supported by the system for the applications. The list of Locales refers to the available user interface (UI) Locales. The list of requested Locales is derived from the Accept-Language header.

During negotiation there is some flexibility. For instance, the language is the most important factor, and the country can help decide the exact locale. A French user may accept a French Canadian user interface if that is the only French version available.

It is also possible that when a user logs in, the user's preferences will specify a list of preferred locales. For example, a user can set German as the choice for the language to be used with the user interface, and set French as the second choice, and set English as the third choice. In most cases, the locales that the user can select from are determined from what the system supports. The system therefore needs to determine which locale the system might use as the user's UI locale. The resulting list of available UI Locale that the system supports comes from certain “installed locale” settings which might exist in the AGS configuration file (i.e., an XML file named “GlobalServices.xml”). The list of preferred UI locales comes from the user preferences, and there must be an exact match between language and country.

For example, consider a user in Europe, who is required to purchase goods and services from various international suppliers. This user is also a bilingual speaker. When this particular user uses a Dynamic Trade Services application, they would prefer to use and participate in both of their preferred languages. A Catalog application, for instance, can retrieve a list of the user's preferred languages from the User Management API. In conjunction with Entitlement aspects, this allows the appropriate catalogs in the required languages to be selected from the database and made available to the user. The user selects a catalog of products in the choice of language. However, the supplier may be anywhere in the world and may not have a price list in the appropriate currency for this particular user. Accordingly, Locale Negotiation would be employed.

In the situations involving negotiation, there may be different cases that would use different elements in the Locale to be matched. For example, the Locale match can be made based on the language and country independently. Alternatively, it can require an exact match of both. To support negotiation with various criteria on the elements, weights can be added for the preference of each element. Several different representative weight criteria as shown below:

| | |
|---|---|
| WEIGHT_MUST | This element always has to exist and match. |
| WEIGHT_OPT | This element is optional, but if it exists, it has |
| | to match. |
| WEIGHT_ALT | This element is an alternative. If the entire |
| | WEIGHT_MUST element matches with more |
| | than one Locale that the system supports, the |
| | one that matches this element will be selected |
| | as preferred. |
| WEIGHT_NONE | This element is not considered in the selection. |

Accordingly, the Locale Negotiation will be performed according to the weight of preference that has been set to each element.

Data formatting 408 will generally require certain support for each type of attribute. For instance the date will require formatting for the USF date format (e.g., “yyyy-MM-dd HH:mm:ss”) to a native date format (e.g., “YY/MM/DDDD”). The formats will generally include versions of DateTime, Date only (with default, short, and long versions), and Time only (with default, short, and long versions). Currency information will generally require a value format from USF numbers to a native currency format. Example formats should include local, no symbol, and International. Numeric information will generally require a value format from USF numbers to native numbers. Example formats should include a decimal character and group separator, integer and decimal formats, and percentage formats.

Custom normalization 410 provides for certain integrations that might have special requirements for supporting normalization from special native attributes over to USF attributes (and vice versa). For example, integration with Japanese software might require conversion from imperial calendar to Gregorian calendar. In another locale, the currency locale might need to be determined by combining the information from multiple locales if the present currency locale is “Euro” (or some other multi-member designation). To support these kinds of normalizations, the helper class should provide the capability to add a customized normalization class for the normalization of a particular type of attribute.

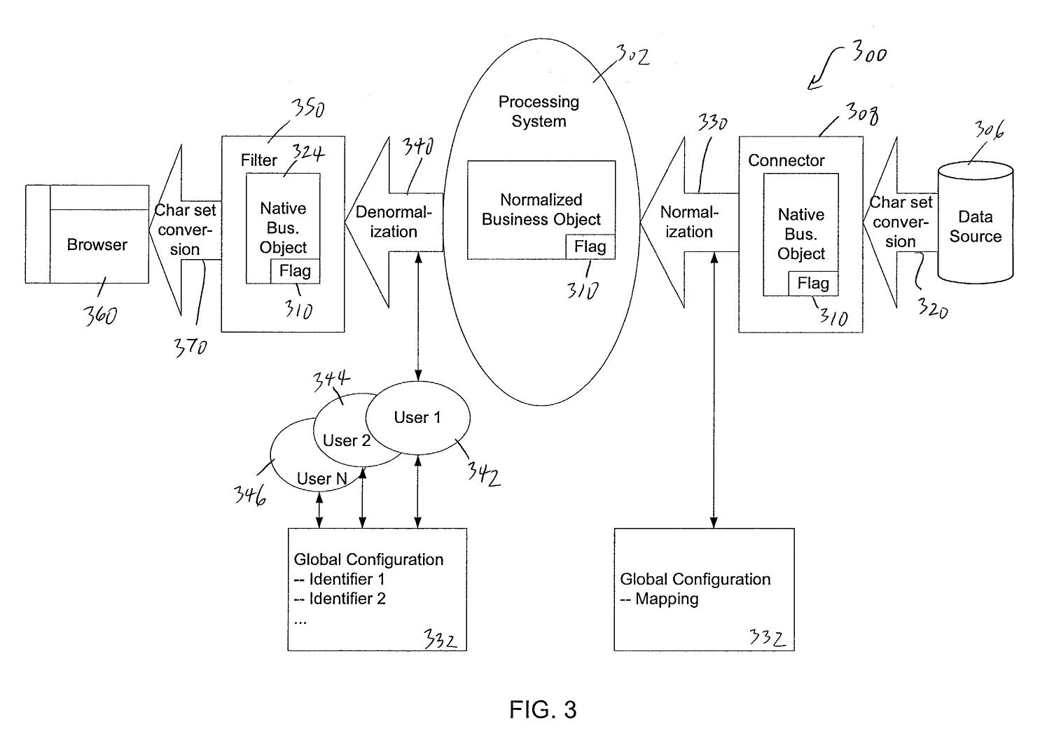

In light of such data and formatting examples, FIG. 5 next shows a block diagram 500 of example data as associated with the representative business objects like those in FIG. 3. The data source 502 is shown to contain data with an indicator of “English” as the language, a date in the format “03/31/00” a currency amount in the format “1,000.00,” and an indicator that the currency is in U.S. Dollars (“USD”). The routine 504 is used to convert the characters over to another format (if needed). In the present example, the Native Business Object 506 is shown to contain the data in virtually the same format. A normalization routine 508 provides normalized data for the normalized business object 510. The normalized data (i.e., USF or other standardized format) attaches an identifier of “en_US” (i.e., English, United States), converts the date to the format “2000-03-31,” the currency to “1000,” and again associates the collective format “en_US” with the U.S. Dollar format. Upon denormalization by the routine 512, the Native Business Object 514 includes the respective formatted data of “English.” “2000.03.31,” “1000,00 USD” and “USD.” The character conversion routine 516 thereafter converts the data into a format to be used by the end user 518 which might access the data via a browser or the like. The data is shown in the format preferred by the user, as might be determined by the user's locale. The respective formatted data “2000.03.31,” “1.000,00,” and “USD” might correspond to a European user utilizing the English language.

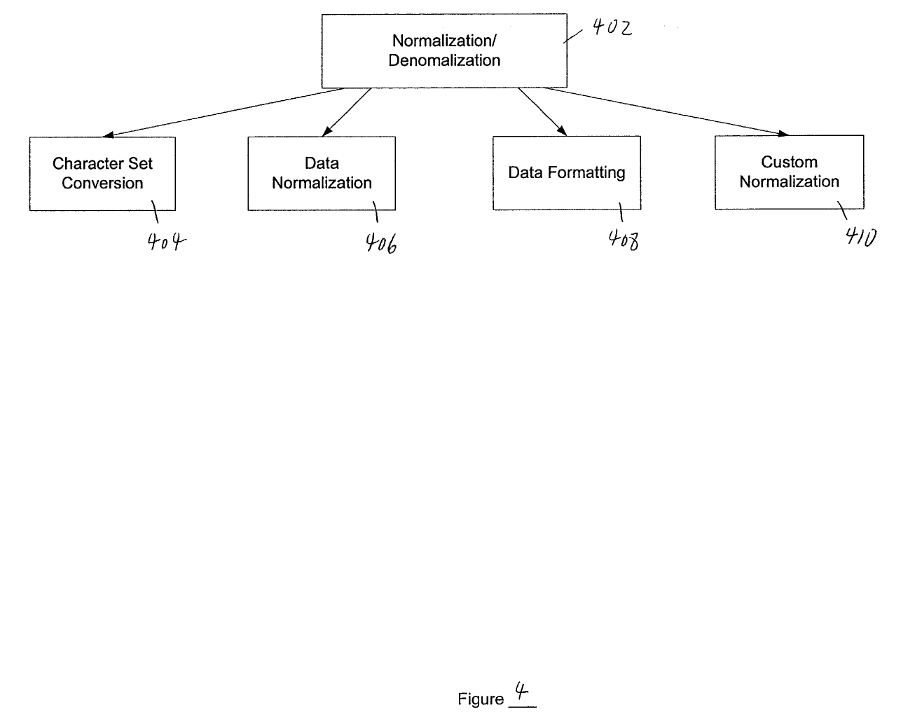

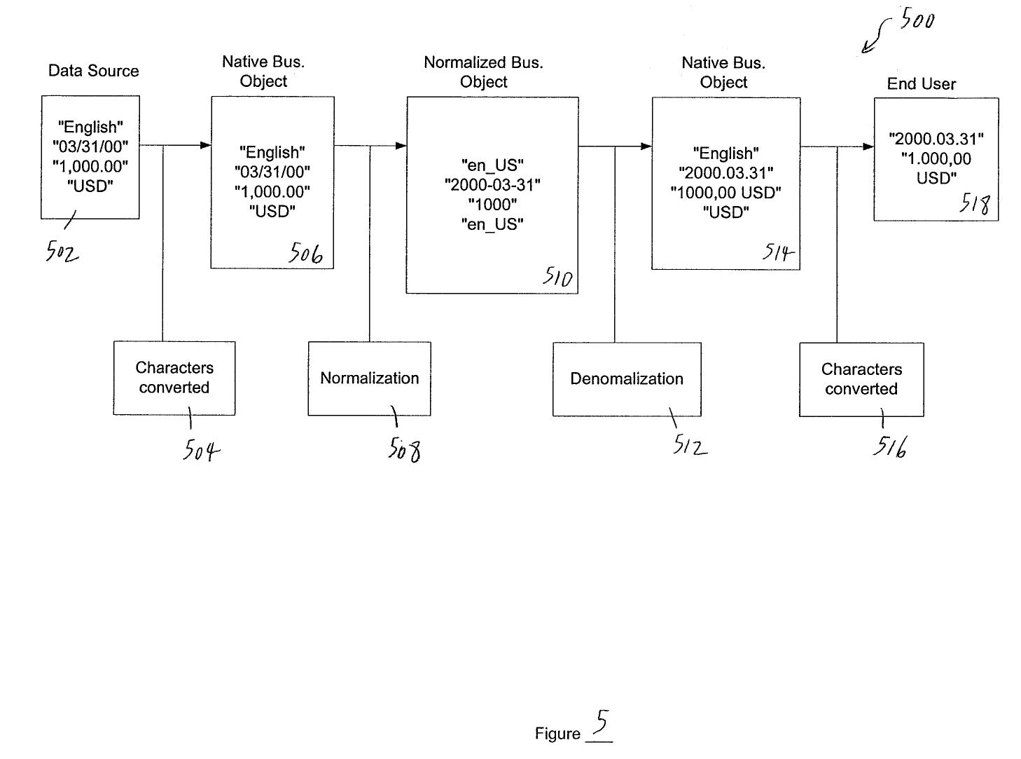

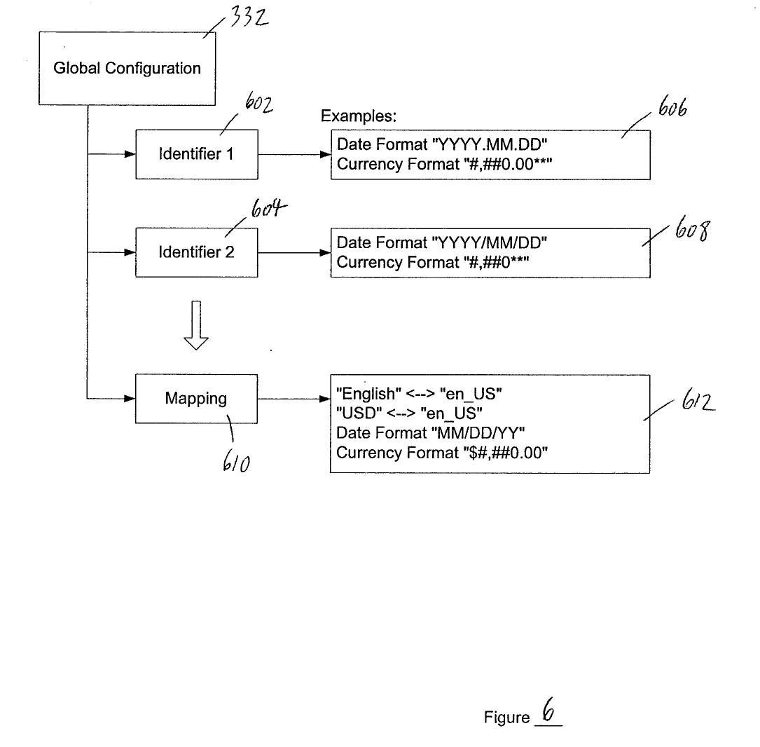

A Global Configuration file 332, as referenced in FIG. 3 above, can be used to store formatting information associated with different types of tags in the file. FIG. 6 shows an Identifier 1 (602) having example date and currency formats 604. Identifier 2 (606) is shown to have a different set of data and currency formats 608. Depending upon the identifier associated with a particular user, the proper formatting can be retrieved from the Global Configuration file 332 to denormalize the data into the required format. Also shown stored in association with the Global Configuration file 332 is a mapping tag (or identifier) 610 that identifies certain mapping constraints 612 that might be used. For instance, “English” might be associated with locale “en_US,” and date and currency formats can similarly be mapped for performing normalization.

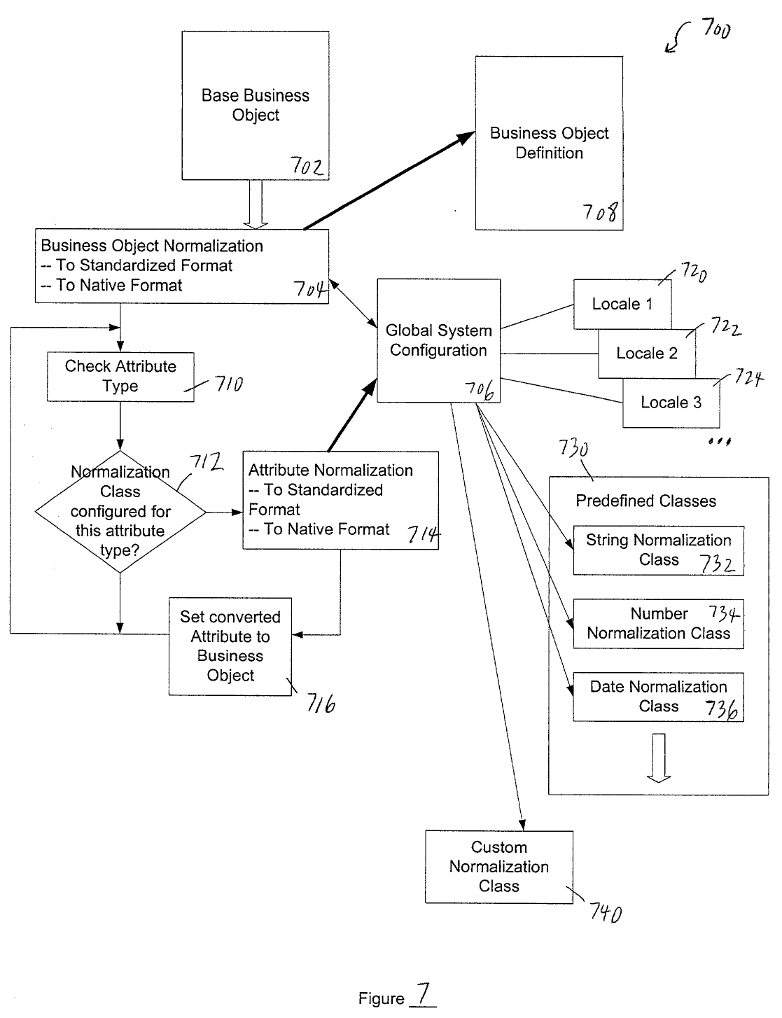

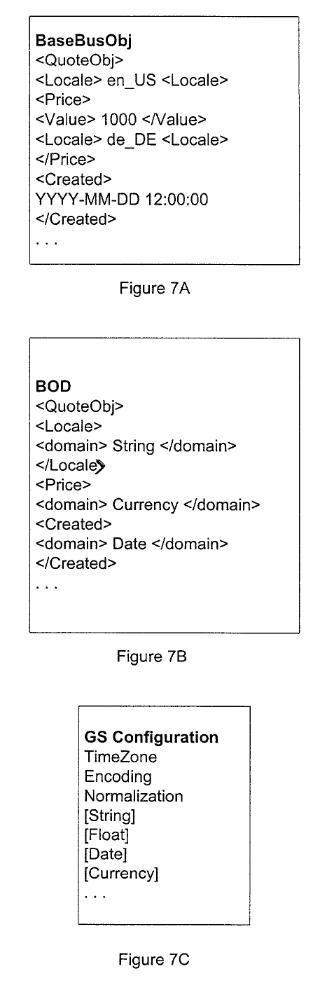

FIG. 7 next shows certain representative steps and associated data blocks 700 which might be used in normalizing a business object and creating a standardized business object definition. To normalize or denormalize the business object 702, an instance of a business object normalization is created (i.e., BusObjNormalization) 704. In particular, the business object 702 might include the representative information and parameters shown in FIG. 7A.

This particular instance is created by providing a system configuration instance, or global system configuration file 706, that is to be used for normalization. The Global System settings will be used (for instance) for character set encoding, time zone calculation, and/or formatting information for each locale. The Global System settings will also be used for local name mapping and normalization class definitions for all such normalization/denormalization to be performed using this particular normalization instance. A particular locale—based upon the user and the user's location—shown as Locale 1 (720), Locale 2 (722), Locale 3 (724) and so forth, is provided to the Global System to help select and determine what data in the Global System configuration 706 is to be used. These might be representatively named “ALocale1,” “ALocale2,” and so forth.

To normalize a business object, the Base Business Object (i.e., BaseBusObj) 702 will be provided, along with the context for the particular method to be used. Data can generally be converted to a standardized format (i.e., toUSFBusObj( )), or a native format (i.e., toNativeBusObj( )). Note that in this particular example of the normalization/denormalization process, “USF” is used for the normalized form of data, and “Native” is used for the denormalized form of data. For either method chosen, the Business Object Definition (BOD) 708 will be retrieved, and a routine will sequentially go through each attribute type in the definition. For this example, a representative BOD might contain the information and parameters shown in FIG. 7B.

Step 710 shows the present attribute type being checked. In the decisional step 712, if the normalization class for the attribute type is defined in the Global System configuration 706, then an appropriate method for attribute normalization 714 will be called to convert the particular attribute. For normalization, the method will be used to retrieve the data to a standardized format (i.e., a method named “toUSFString( )”). For denormalization, the method will be used to retrieve the data to a native format (i.e., a method named “toNativeString( )”). A representative GS configuration might contain the information and parameters in FIG. 7C.

Block 730 shows certain predefined classes, including for instance a string-normalization class 732, a number-normalization class 734, and a date-normalization class 736, and so forth. Block 740 shows the ability to create custom normalization classes. The attributes are retrieved according to the appropriate classes.

After the converted attribute data has been retrieved in step 714, the attribute data is then put back into the business object in step 716. This process loops back and repeats itself for each attribute in the business object until all the attributes have been converted.

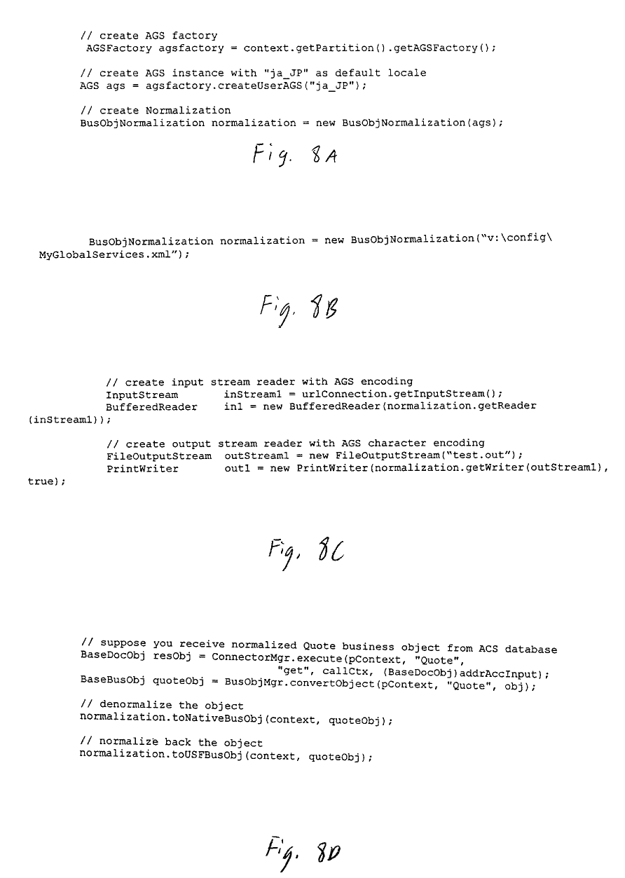

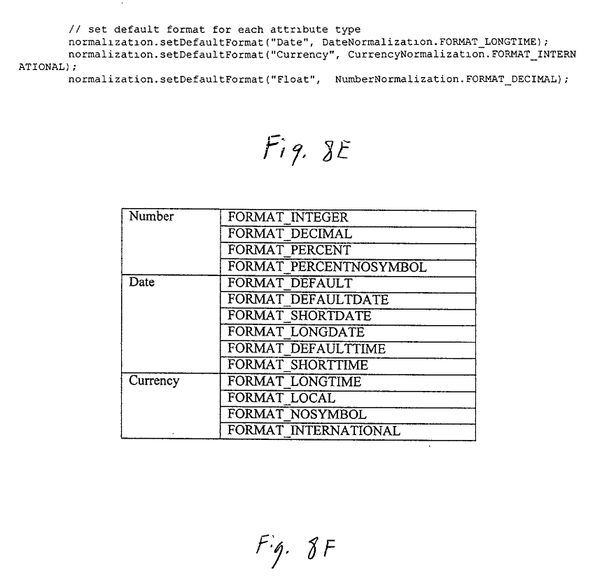

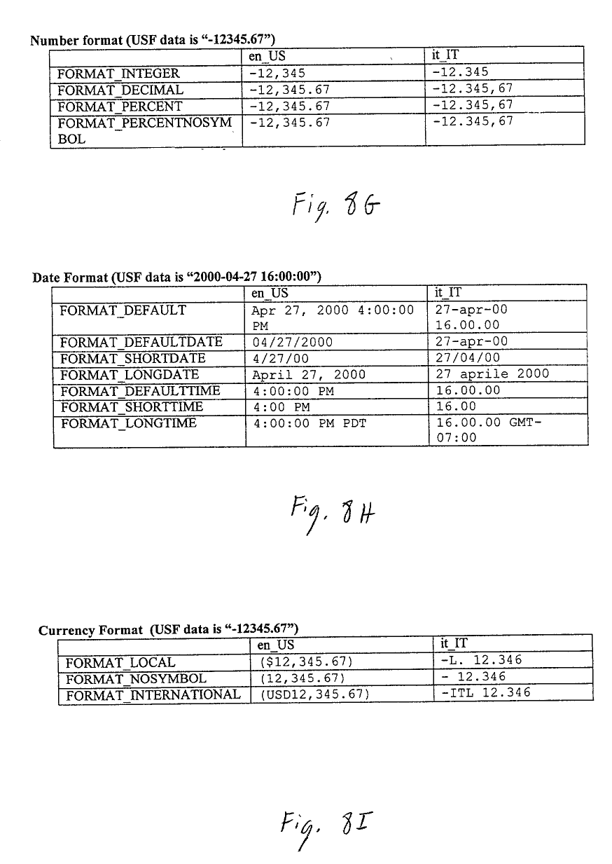

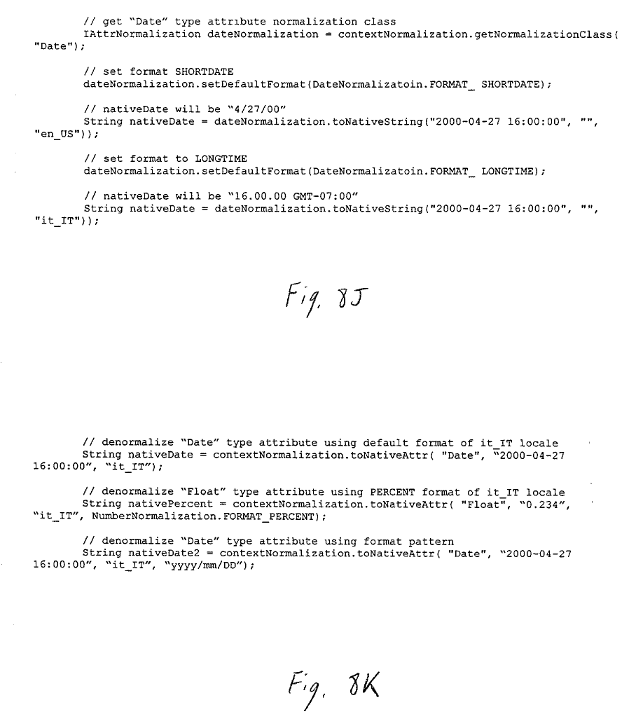

The ability to normalize (and denormalize) objects can be provided as an Application Interface (API) to the overall Globalization System. Using the Asera system as representative example, a normalization object in the Asera Globalization System (AGS) is created by first retrieving an AGS instance or configuration file that is to be used for normalization. The example code in FIG. 8A provides a method to retrieve the AGS from context and thereafter pass it to the Business Object Normalization (i.e., BusObjNormalization) constructor. Another way is to create a BusObjNormalization with the AGS configuration file name, as shown by the representative code in FIG. 8B.

For character set encoding, a normalization class can be used to get an Input Stream Reader and Output Stream Reader which utilizes the character encoding setting in the AGS configuration file. Representative code is shown in FIG. 8C. The Reader/Writer can be used to read in from, or write out to, the stream in native encoding. The Reader/Writer can also be used in a routine FileConnector or URLConnector wherein the data source is not in “UTFS” character encoding.

To normalize or denormalize a business object, a call is made to the methods “toUSFBusObj( )” and “toNativeBusObj( )” in the normalization class. Representative code illustrating such a call is shown in FIG. 8D. The call of the method toNativeBusObj( ) will denormalize each attribute in the example “Quote” object using the AGS time zone, locale mapping, and locale formatting. A call of the method toUSFBusObj( ) will do the opposite processing. The locale of the formatting will be the system and data locale of the AGS. The default locale can also be overwritten via calling a method such as: normalization.setLocaleName (“it_IT”). This method will provide the normalization instance with the appropriate ALocale to use when the normalization method is called. For example, if the date is “04-27-2000 12:00:00” in USF format, and the System Data Locale is “en_US,” then the default normalization Date form is “Mar. 31, 2000.” After the LocaleName is set to “it_IT,” the denormalization string will be “31-mag-69,” which is the denormalization date format for an Italian locale.

Additionally, the kind of format can be specified to be used for denormalization. FIG. 8E shows representative code for setting the default format for date, currency, and numeric formats. The types of different formats will depend on each attribute type, and the table in FIG. 8F provides a set of representative format types that might be supported.

FIGS. 8G-8I next show example of the format using the format type and locale. FIG. 8G shows representative number formats, FIG. 8H shows representative date formats, and FIG. 8I shows representative currency formats. In each instance, the comparable formats for English, U.S. (“en_US”) and Italian, Italy (“it_IT”) are shown. Of course, other locales and languages would rely on still other localized formatting.

Generally, the same locale and format type are used for both normalization and denormalization. For example, you cannot generally denormalize the Date attribute by using a SHORTDATE format and then normalize back again using the LONGDATE format, as the SHORTDATE format data cannot be parsed back into the USF using the LONGDATE format style. Some precision of the data might also be lost in the normalization process. For example, the ACS might keep both data and time information in the Date attribute. An external system that interfaces with the ACS (i.e., an ERP system) might only provide the date information. The time information will thereby be filled with the system default time at normalization and be lost during the denormalization.

To perform attribute by attribute normalization, the normalization class of a particular attribute type is retrieved from the BusObjNormalization class by calling a “get normalization class” method (i.e., getNormalizationClass). Representative code for using such a method is shown in FIG. 8J. First the “Date” type attribute normalization class is retrieved. The date format is set to SHORTDATE. The nativeDate will therefore be in the form “4/27/00.” The time format is set to LONGTIME. Thereafter, the native date will be “16.00.00 GMT-07:00.”

Alternatively, each attribute can be denormalized by calling a method “toNativeAttr” which is part of the BusObjNormalization instance, and passing in the data type as a parameter. Representative code is shown in FIG. 8K for denormalization of the following: the “Date” type attribute using a default format of it_IT locale; the “Float” type attribute using PERCENT format of it_IT locale; the “Date” type attribute using a format pattern.

The AGS configuration file can be divided up into different sections according to the needs of the particular system. In the present example, an <AGSConfig> section might contain the following: <CharacterEncoding> tag—which will be used for character set conversion for input/output streams; <SystemTimeZone> tag—which will be used to determine the system time zone. The time zone conversion will be done between this setting and the AGS time zone of the AGS object; <DataLocale> tag—which will be used to determine the default ALocale to use for the formatting in the normalization. It can be overridden by the user via the method setLocaleName( ).

A <LocalConfig> section provides for the definition of format patterns for currency, date, and time for each Locale. Default format patterns (i.e., in Java, or some other functional language) will be used if there is no custom definition for the requested locale.

A <mappingDefinition> section is used to define any string mapping which is related to the AGS and ALocale. For the normalization API, representative locale mappings might be defined as follows:

(1) LocaleMap. This is a locale string map for Object Locale and Currency Locale. Three mapsets might generally need to be defined in order for the ObjectLocale mapping and the CurrencyLocale mapping to function properly. These representative mapsets include:

(a) Java locale name, which equals the ACS System locale name.

(b) BusinessObject Locale Name mapping (i.e., referred to in the ACS example as “ObjLocale”). For instance, if the SAP ERP system uses “E” for an English System Identifier, then “E” can be mapped to “en_US” the normalized business object is created.

(c) Currency Attribute Locale Name mapping (i.e., referred to in the ACS example as “CurrencyLocal”). For example, if a company such as CyberSource uses “USD” as the US currency identifier, then “USD” can be mapped to “en_US” when a normalized currency attribute is created, as long as the mapping is so specified in this section.

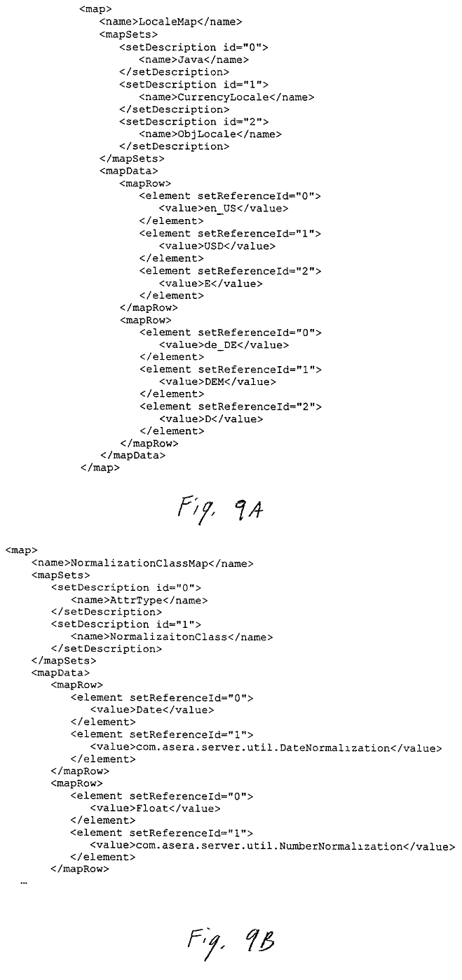

By way of example, FIG. 9A shows a LocaleMap definition. Note that no particular order is required, nor are any specific identifiers (“id”). The mapset name, however, needs to be consistent so that the defined mapping can be located and utilized within the configuration file.

(2). Normalization Class Map (i.e., “NormalizatonClassMap”). This provides a list of the normalization class to handle attribute normalization. The attribute type name, that the normalization class handles with this AGS, will be defined by id =0 (i.e., AttrType). The class to handle the normalization will be specified by id =1 (i.e., Normalization Class). In this particular mapping, the particular mapset name does not matter, but the id does matter. By way of example, FIG. 9B shows representative code for a normalization class map that uses this structure.

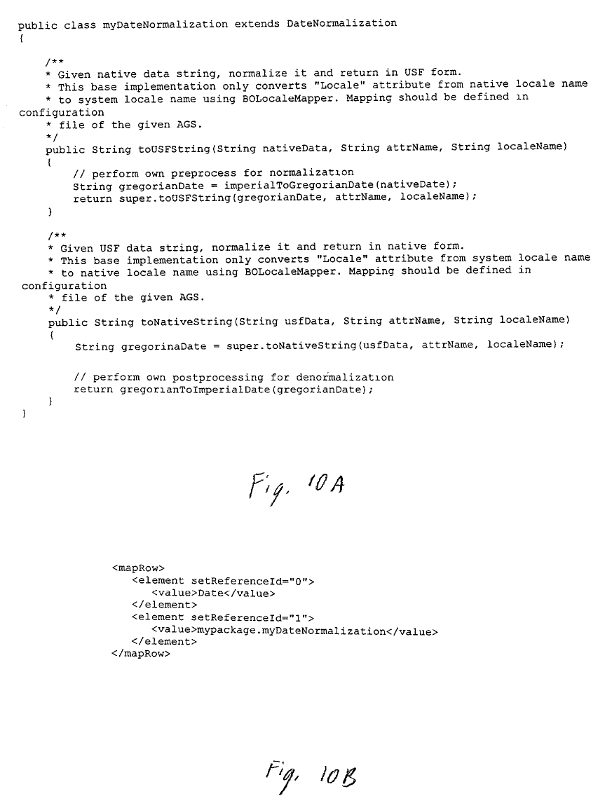

Customization (as described above) allows for the special handling of normalization for a particular attribute. A user can build and/or add a specific normalization class by adding to the AGS configuration. The representative code shown in FIG. 10A provides for a customized Date Normalization routine. Given a native data string, the routines will normalize it and return it in USF form. Conversely, given a USF data string, the routines will normalize it and return it in the native form. The base implementation is shown to only convert the Locale attribute from a native locale name to a system locale name using a routine called BOLocaleMapper. Mapping should thereafter be defined in the configuration file of the given AGS. FIG. 10B next shows representative code wherein to use the class shown in FIG. 10A for date type attribute normalization, the AGS configuration file definition is changed via reference to the value of the reference id.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given here but should be defined by the following claims and their full scope of equivalents.

1. A globalization system for processing multi-locale information being sent to and received from a variety of external sources, the globalization system comprising:
a server domain having information objects to be processed and displayed;
at least one locale indicator associated with each information object; and
a locale-sensitive mechanism associated with processing the information objects for accessing certain locale specific information,
whereby the locale-specific information is used to uniformly process the information object according to certain requirements of the locale.

2. The globalization system of claim 1, wherein the multi-locale information includes multilingual information.

3. The globalization system of claim 1, wherein the locale-specific information includes locale-specific translated text and images.

4. The globalization system of claim 3, wherein the locale-specific information is stored in various resource files.

5. The globalization system of claim 4, wherein the resource files are external to the server domain.

6. The globalization system of claim 3, wherein the locale-specific translated text and images are used to display the information to a user, based upon the locale of the user.

7. The globalization system of claim 6, wherein the locale-specific information includes date, time, and time-zone formatting.

8. The globalization system of claim 6, wherein the locale-specific information includes currency formatting.

9. The globalization system of claim 6, wherein the locale-specific information includes numeric formatting.

10. A multi-locale processing configuration for uniformly processing multilingual information being sent to and received from a variety of external sources, the processing configuration comprising:
a processing domain for containing information objects to be processed;
at least one locale indicator associated with each information object; and
a mechanism for accessing certain locale-specific information,
whereby the locale-specific information is used for the parsing, formatting, and transformation of multilingual data in a multilingual software environment.

11. The multi-locale processing configuration of claim 10, wherein the information objects include methods and data members that can be instantiated in different ways.

12. The multi-locale processing configuration of claim 10, wherein the information objects are instantiated via programming calls to the objects.

13. The multi-locale processing configuration of claim 10, wherein the information objects are instantiated via configuration of the objects.

14. The multi-locale processing configuration of claim 10, wherein the information objects are instantiated via a combination of programming calls to the objects and configuration of the objects.

15. A multi-locale processing configuration for uniformly processing multi-locale information being sent to and received from a variety of subsystems, the processing configuration comprising:
a processing domain for running the variety of subsystems having a locale indicator;
at least one interface associated with each different subsystem, the interface being used to facilitate the handling of different formatting and data conventions between subsystems;
a mechanism for accessing locale-specific information based upon the locale indicator for each subsystem;
whereby the subsystems interact with each other based upon the locale-specific information, and whereby the code within the interface frees developers from needing certain detailed knowledge about any particular language.

16. The multi-locale processing configuration of claim 15, wherein the configuration further includes at least one class associated with each different subsystem, the class being used to facilitate the handling of different formatting and data conventions.

17. The multi-locale processing configuration of claim 16, wherein the interface is programmatically associated with each subsystem by a developer.

18. The multi-locale processing configuration of claim 17, wherein the subsystems include applications, servers, and adapters.

19. A multi-locale processing configuration for performing normalization and de-normalization of data objects being used within a processing system, the configuration comprising:
a processing domain having a variety of information objects;
at least one integration interface for sending and receiving outgoing and incoming un-normalized information objects from an external system;
a normalization routine to normalize the incoming information objects to a normalized representation; and
a de-normalization routine for un-normalizing outgoing information objects from the normalized representation.

20. The multi-locale processing configuration of claim 19, wherein the integration interface is configured through an interface-specific configuration file.

21. The multi-locale processing configuration of claim 20, wherein the configuration file includes configurable mapping interfaces that facilitate normalization between conventions.

22. The multi-locale processing configuration of claim 21, wherein the configuration file is stored external to the interface.

23. The multi-locale processing configuration of claim 21, wherein the mapping interfaces includes character-set encoding normalization.

24. The multi-locale processing configuration of claim 21, wherein the mapping interfaces includes vendor specific naming format normalization.

25. The multi-locale processing configuration of claim 21, wherein the mapping interfaces includes data format normalization.

26. The multi-locale processing configuration of claim 19, wherein the external system includes an end user, and the interface is a user interface that presents data in a locale-sensitive manner.

27. The multi-locale processing configuration of claim 19, wherein the normalized representation includes Universal System Format.
